(19) United States
(12) Patent Application Publication
(10) Pub. No.: US 2025/0026987 A1
(43) Pub. Date: Jan. 23, 2025

(54) ELECTRIC ADIABATIC HEATER FOR OLEFIN PRODUCTION

(71) Applicant: LUMMUS TECHNOLOGY LLC, Houston, TX (US)

(72) Inventor: Kandasamy M. Sundaram, Houston, TX (US)

(73) Assignee: LUMMUS TECHNOLOGY LLC, Houston, TX (US)

(21) Appl. No.: 18/757,122

(22) Filed: Jun. 27, 2024

Related U.S. Application Data
(60) Provisional application No. 63/514,020, filed on Jul. 17, 2023.

(51) Int. Cl. C10G 9/36; B01J 12/00; B01J 19/00; B01J 19/08; B01J 19/24; C10G 9/24

(52) U.S. Cl. CPC C10G 9/36; B01J 12/005; B01J 19/0013; B01J 19/0026; B01J 19/087; B01J 19/2445; C10G 9/24; B01J 2219/00103; B01J 2219/00132; B01J 2219/00159; C10G 2300/4006; C10G 2300/708; C10G 2300/807; C10G 2400/20

(57) ABSTRACT

Systems and processes for cracking hydrocarbons to produce olefins herein includes heating a hydrocarbon feedstock or a mixture comprising steam and hydrocarbons to a first temperature to form a preheated feed, and also include electrically heating steam to a second, higher, temperature to form a superheated reaction steam. The preheated feed is then mixed with the superheated reaction steam to form a reaction mixture at a cracking temperature, thereby cracking the hydrocarbons to form olefins, producing a reaction effluent. The reaction effluent is then quenched and separated effluent to recover the olefins.

### FIELD OF THE DISCLOSURE

Embodiments of the present disclosure generally relate to steam cracking of hydrocarbons to form olefins.

### BACKGROUND

To produce ethylene, a hydrocarbon, such as ethane, LPG, naphtha and/or gas oils, is typically heated in the convection section of a fired heater and mixed with dilution steam. The mixture (hydrocarbon plus dilution steam (HC+DS)) is further superheated in the convection section of the fired heater and then enters the radiant section of the fired heater. This mixture (HC+DS) is thermally cracked at high temperatures (such as 700° C. to 900° C., for example) and at short residence times (such as 0.2 to 0.4 sec, for example) in tubular reactors. The effluent is quickly cooled in transferline exchangers generating steam and thereby the reaction is frozen quickly. The cooled effluents are then sent to a recovery section for product recovery.

With a fired heater, when a fluid is heated, the associated metal temperature is also hot and the achievable temperature is limited by the metallurgy. Thus, maximum temperatures of the tubes within the radiant section are often limited. Furthermore, fired heaters produce a significant amount of carbon dioxide, a further disadvantage of a fired system.

### SUMMARY OF THE CLAIMED EMBODIMENTS

In one aspect, embodiments disclosed herein relate to a process for cracking hydrocarbons to produce olefins. The process includes heating a hydrocarbon feedstock or a mixture comprising steam and hydrocarbons to a first temperature to form a preheated feed. The process also includes electrically heating steam to a second, higher, temperature to form a superheated reaction steam. The preheated feed is then mixed with the superheated reaction steam to form a reaction mixture at a cracking temperature, thereby cracking the hydrocarbons to form olefins, producing a reaction effluent. The reaction effluent is then quenched and separated effluent to recover the olefins.

In another aspect, embodiments disclosed herein relate to a system for cracking hydrocarbons to produce olefins. The system includes a heating system configured for heating a mixture comprising steam and hydrocarbons to a first temperature to form a preheated mixture. The system also includes an electrical heating system configured for electrically heating steam to a second, higher, temperature to form a superheated reaction steam. A mixing system is also provided, the mixing system being configured for mixing the preheated mixture with the superheated reaction steam to form a reaction mixture at a cracking temperature. The system further includes a reaction zone, such as an adiabatic reaction zone, for adiabatically cracking the hydrocarbons to form olefins, producing a reaction effluent having a fourth temperature. Further, a quench system is provided for quenching the reaction effluent, and a separation system is provided for separating the reaction effluent to recover the olefins.

Other aspects and advantages will be apparent from the following description and the appended claims.

### BRIEF DESCRIPTION OF DRAWINGS

FIG. 1 illustrates a simplified process flow diagram of a system for steam cracking of hydrocarbons according to one or more embodiments disclosed herein.

FIG. 2 illustrates a simplified process flow diagram of a system for steam cracking of hydrocarbons according to one or more embodiments disclosed herein.

FIG. 3 illustrates a simplified process flow diagram of a system for steam cracking of hydrocarbons according to one or more embodiments disclosed herein.

FIGS. 4 and 5 illustrate ethylene yield curves illustrating expected ethylene yields, as a function of temperature and residence time, that may be achieved according to one or more embodiments disclosed herein.

### DETAILED DESCRIPTION

Embodiments herein relate to steam cracking of hydrocarbons to produce olefins. More particularly, embodiments herein relate to steam cracking of hydrocarbons to produce olefins where various heating duties are supplied by electric heaters. Even more particularly, some embodiments herein are directed toward systems and processes to produce olefins using only electrical heating to crack hydrocarbons in an adiabatic reactor.

A hydrocarbon feedstock to be cracked in reaction systems according to embodiments herein may be any one of a wide variety of feedstocks, and may include individual hydrocarbon components (e.g., methane, ethane, propane, butane, etc.) or mixtures of two or more hydrocarbons (e.g., natural gas, butanes, pentanes, naphtha, gas oils, etc.). In some embodiments, the hydrocarbon feedstock may be derived from a whole crude oil, and may include one or more fractions of the crude oil, including light fractions (naphtha, diesel, etc.) as well as heavy fractions (gas oil, heavy cycle oil, etc.) or residue fractions that have been conditioned for use as a cracker feed.

The hydrocarbon feedstock, or a mixture of hydrocarbon feedstock and steam, is preheated to a temperature below the onset of the cracking reaction, such as to a temperature below 650° C. In some embodiments, the hydrocarbon feedstock, or a mixture of hydrocarbon feedstock and steam, is preheated to a temperature at which low rates of cracking are encountered, such as to a temperature below 750° C. In some embodiments, the hydrocarbon feedstock is heated to a desired preheat temperature, such as a temperature in the range from 300° C. to 650° C. In some embodiments, the hydrocarbon feedstock is heated to a first temperature, such as 150° C. to 350° C., mixed with steam, and then further heated to the desired preheat temperature, such as 300° C. to 750° C. In various embodiments, the preheat temperature may be in a range from a lower limit of 150° C., 200° C., 250° C., 300° C., 350° C., 400° C., 450° C., or 500° C. to an upper limit of 550° C., 600° C., 625° C., 650° C., 675° C., 700° C., 725° C., or 750° C., where any lower limit may be paired with any upper limit.

The preheated hydrocarbon feedstock is then rapidly heated to a cracking temperature and cracked to form olefins, such as ethylene, propylene, and butenes, among other products. Cracking temperatures are those greater than the temperature at which the onset of cracking begins, which may depend upon the hydrocarbon feedstock. Cracking temperatures used in embodiments herein may be in a range from 750° C. to about 1300° C., such as from 900° C. to 1250° C., or from 950° C. to 1200° C., for example. In various embodiments, cracking temperatures may be in a range from a lower limit of 750° C., 780° C., 800° C., 850° C., 900° C., 925° C., 950° C., 975° C., 1000° C., 1025° C., or 1050° C. to an upper limit of 950° C., 975° C., 1000° C., 1025° C., 1050° C., 1100° C., 1150° C., 1200° C., 1250° C., or 1300° C., where any lower limit may be paired with any mathematically compatible upper limit.

To achieve the desired cracking temperatures, embodiments herein directly heat the preheated hydrocarbon feedstock, or the preheated hydrocarbon plus steam mixture, using superheated steam. Superheated steam used for the reaction according to embodiments herein is generated via electrical heating, as will be described further below. The superheated steam used to provide the heating of the hydrocarbons to cracking temperatures may be at a temperature in a range from 925° C. to about 1400°, for example. Admixture of the superheated steam with the preheated hydrocarbon feedstock will rapidly increase the temperature of the hydrocarbons to cracking temperatures, resulting in the cracking of the hydrocarbons to form ethylene and other cracked hydrocarbon products. In various embodiments, the superheated steam may be at a temperature in a range from a lower limit of 925° C., 950° C., 975° C., 1000° C., 1025° C., 1050° C., or 1100° C. to an upper limit of 1050° C., 1100° C., 1150° C., 1200° C., 1250° C., 1300° C., 1350° C., or 1400° C., where any lower limit may be paired with any mathematically compatible upper limit. Following admixture of the superheated reaction steam with the hydrocarbon feedstock, the endothermic cracking reaction then proceeds adiabatically, cooling the reacting mixture to an extent. In some embodiments, where it is desired to maintain the reaction temperature, additional heat input may be provided to offset the endothermic reaction. To maintain high selectivity to ethylene, reaction conditions (feed rates, feed temperatures, etc.) may be selected to provide a reaction effluent having a temperature greater than 750° C., such as greater than 800° C., greater than 825° C., greater than 850° C., greater than 875° C., or greater than 900° C.

The reaction effluent contains a variety of components, the concentrations of which are dependent upon the feedstock as well as the reaction severity (reaction temperature and residence time at cracking temperatures). Generally, the residence time at cracking temperatures is less than 0.5 seconds (less than 500 milliseconds). Due to the very high temperature of the superheated steam that may be used according to embodiments herein, and the minimal coking that results due to the direct heating of the hydrocarbons (contrary to radiant coils in a fired furnace), residence times used in embodiments herein may be in a range from 10 to 200 milliseconds, such as from 20 to 180 milliseconds, 30 to 170 milliseconds, 50 to 160 milliseconds, or 60 to 150 milliseconds, where any lower limit may be combined with any upper limit.

As noted in U.S. Pat. No. 6,685,893, it is generally recognized in the industry that for most feedstocks, and especially for heavier feedstocks such as naphtha, shorter residence times will lead to higher selectivity to ethylene and propylene since secondary degradation reactions will be reduced. Further it is recognized that the lower the partial pressure of the hydrocarbon within the reaction environment, the higher the selectivity. Reactors according to embodiments herein may provide both higher temperatures than may result in a fired furnace, as well as short residence times, thus providing an advantageous yield of ethylene and propylene.

Following the rapid heating and short residence time at cracking temperatures, the reaction effluent may be rapidly cooled, quenched, to halt the cracking reaction. For example, direct or indirect heat exchange may be used to cool the reaction effluent to a temperature below about 700° C., such as to a temperature in a range from about 300° C. to about 600° C. Indirect heat exchange quenching of the reaction mixture may be conducted, for example, to preheat a water or steam stream, the hydrocarbon feedstock, or a hydrocarbon feedstock-steam mixture. In other embodiments, direct quenching of the reaction mixture may be conducted via admixture of the reaction effluent with steam, a cycle oil, gas oil, or other hydrocarbon medium.

The resulting quenched reaction effluent may then be fed to a cooling and recovery section to further cool and separate the effluent to recover the water/steam and one or more hydrocarbon fractions. The recovery section may include various separation devices, such as distillation columns, extractive distillation, flash drums, strippers, and other unit operations commonly used for separation of mixtures to recover one or more chemical streams, such as ethylene, propylene, and butenes, among others, such as a higher boiling pyrolysis oil fraction.

The hydrocarbon-steam mixture may have a steam to hydrocarbon ratio in a range from 0.05 to 1.2 w/w. As the preferred steam to hydrocarbon ratio may depend upon the hydrocarbon feedstock being processed, as well as the desired preheat temperature, whether below onset of cracking or with a small amount of cracking, steam to hydrocarbon ratios for the hydrocarbon-steam mixture may be in a range from a lower limit of 0.05, 0.1, 0.15, 0.2, 0.25, 0.3, 0.35, 0.4, 0.45, or 0.5 w/w to an upper limit of 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1.0, 1.1, or 1.2 w/w, where any lower limit may be combined with any mathematically compatible upper limit.

The hydrocarbon feedstock, or hydrocarbon-steam mixture may be mixed with the superheated reaction steam at an appropriate rate to form a reaction mixture having the desired cracking temperature. The ratios used may depend upon the desired steam to oil ratios, reaction residence times, initial temperature of the streams, as well as the heat capacity of the hydrocarbon feedstock, among other factors. In some embodiments, the reaction mixture may have a steam to hydrocarbon ratio in a range from a lower limit of 0.25, 0.5, 0.75, 1.0, 1.5, or 2.0 w/w to an upper limit of 3.0, 4.0, 5.0, 6.0, 7.0, 8.0, 9.0, 10.0 or higher, where any lower limit may be combined with any upper limit.

Heating of the hydrocarbon feedstock may be conducted in one or more exchangers or heaters. For example, heat recovery from various process streams may be used to heat the hydrocarbon feedstock via indirect heat exchange. Additionally, or alternatively, electric heaters may be used to heat the hydrocarbon feedstock. The electric heaters may be radiative type electric heaters, direct heating type electric heaters, inductive type electric heaters, or inductive heating with susceptors.

Heating of the dilution steam, and heating of the hydrocarbon feedstock plus dilution steam mixture may be conducted in similar manners. For example, heat recovery from various process streams may be used to heat the dilution steam or the hydrocarbon feedstock plus dilution steam via indirect heat exchange. Additionally, or alternatively, electric heaters may be used to heat the dilution steam or the hydrocarbon feedstock plus dilution steam mixture. The electric heaters may be radiative type electric heaters, direct heating type electric heaters, inductive type electric heaters, or inductive heating with susceptors.

Heating of the superheated reaction steam may also be conducted in similar manners. Initial heating of the steam may be performed by heat exchange (heat recovery) against various process streams. Heating of the steam to the desired reaction steam temperatures may be performed using electric heaters, and in particular embodiments, using inductive heating with susceptors. For example, susceptor particles may be disposed within a tube receiving a steam feed, the susceptor particles being heated via a current applied across an electric coil disposed external to the tube, thereby heating the steam feed to very high temperatures, such as greater than 950° C. or greater than 1000° C., as noted earlier. Such reaction steam temperatures as achievable with electric heating, such as inductive type electric heating with susceptors, provides for a reaction mixture having temperatures much higher than typical for fired heaters.

Resistive heating (radiation), direct resistance heating (using radiant coil as resistance) and inductive heating differ in mode of heating. Inductive heating with susceptors is another excellent method of heating, as with this approach only the fluid is heated. Hence all electric energy is directed to heating dilution steam and the heat is generated internally, as there is no heating element for radiation.

As a result of the electric heating according to embodiments herein, very high temperatures can be achieved. With high temperature steam and moderate temperature of hydrocarbon, enough reaction temperature can be achieved. The reaction takes place adiabatically, and after the reaction, the reaction effluent is rapidly cooled in exchangers and sent to a product recovery section.

With a fired heater, when a fluid is heated the associated metal temperature is also hot and the achievable temperature is limited by the metallurgy. In contrast, embodiments herein utilize resistive heating, induction heating or direct restive heating to heat the complete reaction mixture or a portion thereof.

The advantage of cracking hydrocarbons according to embodiments herein is significant improvement in run length and higher selectivity to olefins. When a whole reaction mixture is heated by a fired heater or by an electric heater, the heat is transferred from the heat source (flame in the case of fired heater and heating element in the case of electric heater) to the radiant tube usually by radiation. From the radiant tube to the reaction mixture heat is transferred by convection. During the process of thermal cracking the reaction mixture to produce olefins, a byproduct reaction to the formation of coke is also taking place. Therefore, coke deposits on the walls of the reactor, causing limitations in producing the olefins via fired heaters. After some time, the reaction is stopped, and the reactor is cleaned by steam/air. The reaction is usually carried out in tubular reactors. The coke deposition depends upon the tube temperature. When it is heated by a fired heater or electric heater, the tube is hotter than the process (reaction) mixture. The higher the temperature, higher is the coking rate. Therefore, metal or tube temperature is limited by the amount of acceptable coke depositions. When the reaction is carried out by adiabatic mode, the fluid is hotter than the metal and hence coke deposition rate on the tube walls is reduced and hence gives rise to long run length. Thermal cracking is a homogeneous (surface to volume ratio independent) reaction while the coke forming reactions are heterogeneous in nature. As the reaction is carried out adiabatically in embodiments herein, large tube diameters can be used by keeping the residence time for the reaction and thereby minimizing the coke deposition rate. Small tube diameters are required to increase the heat transfer rate when convective heat transfer has to be used (like using a flame or electric elements to transfer the heat). In the adiabatic reactor according to embodiments herein, the inert substance (dilution steam) is heated to very high temperatures and hence there is no coke deposition. This very high temperature fluid is mixed with hydrocarbon to increase the temperature of the reaction feed mixture, and the tube temperature is equal to fluid temperature and is often low.

The method of supplying heat to the reaction according to embodiments herein is different. As a result tube metal temperature is low. With electrical heating, especially with induction heating, the fluid can be heated to very high temperatures. Only dilution steam is heated to very high temperatures, and hence there is no issue of severe coking in the reactor.

As described above, embodiments herein utilize electric heating to supply energy to a superheated steam stream to conduct the cracking reactions. In some embodiments, there is no fired heater, and all duties are supplied by electric heater. For simplicity we will use electric heater (inductive type) and similar heating with other types (direct resistance or resistance with a radiative type) can be used to facilitate the reaction. In this approach, first the hydrocarbon is heated. (this can be done in an exchanger directly cooling the effluents also since this is low temperature). By using an exchanger for this preheating electrical duty consumption will be reduced. After preheating the hydrocarbon feed it can be mixed with small amount of dilution steam. Dilution with a small amount of steam is not required for all types of feeds and is feed specific. For illustration purposes, we will take a full range naphtha and walk through the invention. Similar concepts can be applied for ethane (gas feed) to gas oils (heavy feed).

Typically, in a fired heater, naphtha is heated and mixed with dilution steam at a weight ratio of 1:0.5 basis (steam to oil (S/O)=0.5 w/w) and then superheated to 600-650° C. in the convection section before entering the radiant section. In the radiant section the reaction takes place. Radiant section is heated to temperatures of 800 to 850° C. (fluid temperature) and the reaction time is typically 200 to 400 milliseconds in tubular reactors with coil ID ranging from 1 inch to 7 inches and lengths from 20 ft to 400 ft in a single pass or multi-pass tubular reactors. The reaction effluent is then cooled by generating superhigh pressure steam or high-pressure steam to 300 to 330° C.

In embodiments herein, a hydrocarbon feedstock is vaporized, for example naphtha is heated to 150-250° C., and then a small amount of steam (S/O=0.05 to 0.2 w/w) is added, and the mixture is further heated to reasonable temperatures in a range from about 400 to about 650° C.). These temperatures and S/O are chosen to eliminate coking during preheating. In the presence of steam, coking is suppressed, which is why above a prescribed temperature, and depending upon the nature of the hydrocarbon feed, a small amount of steam is added and heated. The maximum temperature is kept slightly lower than typical cross over temperature and again to minimize coking during preheating or superheating the feed. Separately, the remaining steam is superheated to very high temperatures (such as greater than 950° C.). If required, additional steam can be used. The heating of the steam to these very high temperatures is done electrically. In the reaction zone, the preheated mixture of hydrocarbon with small amount of steam is mixed with the superheated reaction steam and the reaction mixture is almost instantaneously increased to cracking temperatures. The reaction then proceeds adiabatically producing olefins.

Following a short reaction residence time, such as 30 to 160 milliseconds, the reaction effluent mixture is cooled (quenched) with a regular exchanger and then sent to further heat recovery and to recovery section. As the reaction takes place adiabatically, the reactor can be a tubular reactor with a large diameter or other type of vessels with appropriate residence time. As a result, the coking is reduced significantly. During the reaction there is little to no heat transfer to external media. If it is desired to improve the selectivity to olefins, a small amount of heat can be added (electrical heating) keeping the reaction temperature at slightly higher values. In this case the amount of heat added is very small just to be sufficient for maintaining the temperature. The benefit of adding heat versus slightly increased coking rate has to be judged case by case. Either option will give long run length and higher selectivity compared with conventional fired heaters. With additional heating, selectivity will be higher than the true adiabatic case. In addition, by breaking down the heating in two steps (dilution steam super heating and additional heat) less expensive alloys can be used. When heat is added in the reaction section, it is no longer referred to as an adiabatic reactor and it is called a non-isothermal and nonadiabatic reactor. Other than the nomenclature used, the performance is not affected.

When electricity is used to heat the dilution steam or the reaction steam, as an example, it can be achieved by radiation. In this case, heating element is heated by electricity and radiates to the reaction tube, which is similar to a fired heater. In the direct resistance heater the tube becomes the heating element. The resistance of the tube is used to heat. To avoid electrocution, generally low voltages are used (<100 V) and hence this mode requires very high current since the power requirement is nearly the same for all cases. Alternatively, with inductive heating the tube can be of inductive capable alloy. In addition, susceptors can be used. Susceptors are placed inside the tube producing inductive current, heating the susceptors. At that point, they act like a packed bed. Suitable susceptors have to be selected. One such material is SiC and other high temperature materials are available. Any such material can be used as a susceptor. With a packed tube, the inside heat transfer coefficient is also very high compared with empty tubular reactors. Also, the metal or tube bearing the susceptors may be inductive or may not be inductive. So, the tube temperature will not be high, and will be much lower than the radiative method and hence the coking rate is also low. In addition, only dilution steam is heated to high temperatures and therefore there is no coking in that section. By superheating the steam to supply the reaction heat, the coking rate is reduced. The heating is done electrically and preferably by inductive method. Some example calculations are shown later. With a higher steam to oil ratio, lower dilution steam superheated temperature can be used; however, this requires longer residence time to achieve high conversion.

With adiabatic operation, outlet temperature can be controlled only by controlling inlet temperature and flowrate. Higher inlet temperatures give higher selectivity. However, there are limitations in any system. To be more efficient, a small (or low) conversion of the feed before adding steam is acceptable. At low conversions, the selectivity to olefins is not affected. The feed contains a small amount of steam and hence the coking rate is not high. When conversion has to be maintained or adjusted, again induction heating to the tube in the adiabatic portion can be used. This provides some heat and keeps the gas temperature high. Of course, this increases the potential for coking. Therefore, optimum dilution steam and temperature should be used for best yields. Instead of supplying heat at the outlet, increasing the inlet temperature with slightly higher inlet conversion is preferred. By this approach, the reactor operates always as adiabatic and hence run length is not affected.

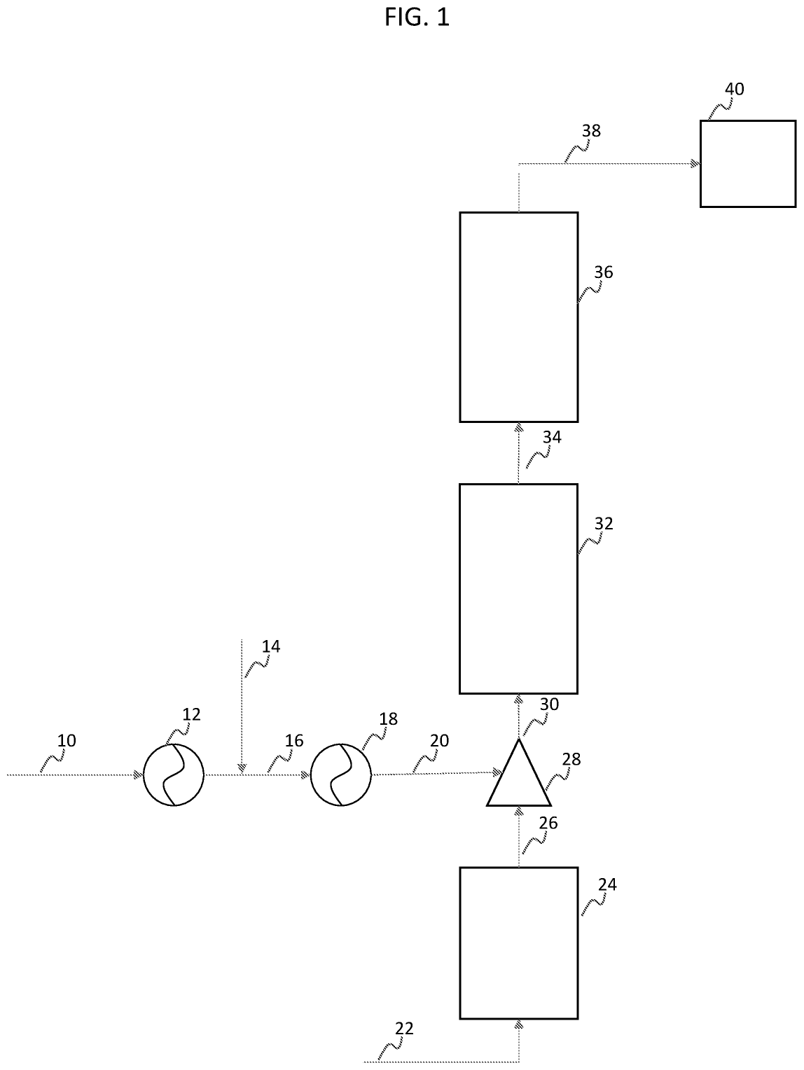

Referring now to FIG. 1, a simplified process flow diagram of a system for steam cracking of hydrocarbons according to one or more embodiments disclosed herein is illustrated. A hydrocarbon feedstock 10, such as naphtha, is preheated in an exchanger 12 to moderate temperatures. Depending upon the feed characteristics, an optional small amount of dilution steam 14 may be added. This amount of dilution steam is typically 0.05 to 0.1 w/w of hydrocarbon and for some heavy feeds it can be as high as 0.6 to suppress coking during vaporization. The mixed feed 16 of hydrocarbon plus dilution steam (HC+DS) is again heated in an exchanger 18 to medium temperatures, resulting in a heated mixed feed 20. Instead of an exchanger, an electrical heater can be employed for this heating of the mixed feed 16. By employing an electrical heater, superhigh pressure steam production can be maximized which can be used in the recovery section. So optimum method of heat transfer medium may be chosen based upon the location, feed type and operating conditions.

Embodiments herein are based on electrical heating for simplicity. For this heating any type of electrical heating can be employed. The hydrocarbon feed is typically heated from 200° C. to 650° C. in this exchanger or heater 18. By using an induction heater heat transfer can be improved without coking since heat is generated in the susceptors. This concept is shown for the main heater. However, that concept can also be applied for this preheater 18. Instead of induction heating, radiative heater (using electrical elements) or a direct resistance heater (electricity is directly applied on the heating coil or vessel) can also be used to preheat the hydrocarbon feed. At these outlet temperatures, the feed conversion is very low (<2%) and hence there is generally no issue of coke formation. However, depending upon the feed and the coil design used for this preheating to higher outlet temperature, some additional conversion can be considered. For example, instead of limiting the temperature to 650° C. for a naphtha feed, increasing the temperature to 700° C. will result in some feed conversion. This results in lower dilution steam duty that will be mixed later. Optimum depends upon case by case, such as by feed type and method of heating.

The remaining dilution steam 22 is superheated in an electric heater 24 to provide superheated reaction steam 26. Electric heater 24 could be radiative type (with resistive elements) or direct resistance type or induction type with or without susceptors. Since only steam is heated in heater 24, the steam can be heated to very high temperatures. With susceptors (induction heating), the outside tube is not controlling the heat transfer and hence higher steam temperature than other modes, such as radiative heating, can be achieved. With a fired heater, due to limitations in metallurgy, achieving steam temperatures higher than 925° C. is difficult. With induction heating, the same metallurgy can be used, and the steam can be heated very easily to higher than 1000° C. The susceptors are good inductive materials (like Silicon carbide) and some of them can withstand temperatures higher than 1400° C. With induction heating and susceptors loaded in the heating equipment, the susceptors are heated by electricity. The outside tube need not be inductive and hence that tube will be at a lower temperature. Since the fluid passes through susceptors, which are placed in the tube like a packed bed, the heat transfer coefficient between the bed and fluid is high. Therefore, the fluid (here steam) is very rapidly heated. With an empty tube, even with inductive or radiative heat transfer, the tube metal has to be heated and then the heat is transferred to the tube. This heat transfer is lower than that of packed bed heat transfer. Thus, inductive heating is primarily used for steam heating in embodiments herein. Inductive heating can also be used for hydrocarbon or hydrocarbon plus dilution steam preheaters 12, 18.

The superheated reaction steam 26 and the preheated hydrocarbon feedstock 20 are then mixed in a mixing device 28. Mixing device 28 may be a simple mixing tee, in some embodiments, or may include static mixers or other devices to facilitate intimate mixing of the reaction steam and preheated hydrocarbon feedstock.

After the high temperature reaction steam 26 is mixed with the preheated hydrocarbon plus steam mixture 20 in a mixer 28, forming reaction mixture 30, the reaction then proceeds adiabatically in reactor 32. The mixing zone 28 can be inside the adiabatic reactor 32 (e.g., integral) or outside (e.g., fluidly connected to the reactor). The adiabatic reactor 32 can be internally insulated or outside insulated. Mixing is fluid-fluid type mixing. Special mixing devices can be used to promote mixing. A simple T or Y type mixing device can also be used. Static mixers can also be used. Due to turbulence, the reaction mixture 30 quickly attains the adiabatic temperature. This reaction temperature, in embodiments herein, is much higher (>900° C.) than normally encountered in typical fired pyrolysis heaters. The cracking reaction proceeds and as a result the temperature drops as the reaction is endothermic. The drop in temperature depends upon the level of conversion. Since the reaction proceeds adiabatically, it depends upon the volume and does not depend upon the surface area. Surface area is required only when there is heat transfer from external to internal or vice versa. Therefore, a large diameter pipe or vessel can be chosen with low external surface area for reactors 32 according to embodiments herein. Coking depends upon the surface area. Since surface area is minimized, coke deposition is minimized and hence no additional pressure drop results due to coking. The volume of the adiabatic reaction section controls the residence time. By properly choosing the flowrates for the given volume and by properly choosing dilution steam flow rates and hydrocarbon feed rates and preheated inlet temperature and superheated dilution steam temperature, high conversion can be achieved. Inductive heating can also be used after mixing in reactor 32, reactor 32 then operating as a non-isothermal nonadiabatic reactor.

Like any pyrolysis reaction, the reaction has to be quenched to preserve the olefins. After the adiabatic reactor, the reaction effluent 34 is quenched using a transferline exchanger 36. Transferline exchanger 36 can be a shell and tube or a double pipe exchanger, for example. Alternatively, direct quenching of the reaction effluent 34 with oil, steam or water is also acceptable. Before quenching it is preferable to get reasonable outlet temperature (>750° C.) so that olefin selectivity is maintained.

After quenching, the procedure is similar to conventional pyrolysis reactor systems. The quenched reaction effluent 38 may be fed downstream to cooling, heat recovery, and separation system 40. Secondary transferline exchangers to generate steam or preheat the feed or other fluids and tertiary exchanger to preheat the feed or to generate low pressure steam or preheat other fluids are acceptable.

Again, any feed from ethane to vacuum gasoil can be used to produce olefins. Any amount of steam from 0.05 to 5 w/w steam to hydrocarbon can be used. Without steam, coking tendency is high and hence a no steam case is not recommended. Very high steam to oil ratios may not be economical but are acceptable. The split of primary steam (mixed with naphtha for preheating) and secondary, reaction, steam (heated alone to high temperatures) can vary from 0 to 1.0.

When there is significant coke deposition, the whole system can be online cleaned with a steam/air mixture or steam alone. If equipment downstream of the mixer has to be cleaned, high temperature steam can be used. This will convert coke to CO/CO2 by steam reforming reactions. Air (ambient or enriched) can be used and that burns coke to CO/CO2. The same air can be used to clean the preheat section, if needed. Air cleaning is required in low temperature zones only.

As described above for embodiments herein, the hydrocarbon plus dilution steam mixture is preheated. Generally, the preheated outlet temperature is kept at moderate level so that conversion of the feed is low or almost nil. To minimize the steam dilution and to minimize the maximum superheated dilution temperature, it is preferable to have some conversion (but small) and to have a high cross over temperature. At low conversions (<30%) coking rate is low. At these low conversions, concentrations of byproducts are low. The final product distribution is not dependent on cross over temperature of small initial conversion. The selectivity increases with reactor outlet temperature. Therefore, for each feed as high cross over temperature as possible is preferred. In this context, a small amount of dilution steam added is helpful to suppress coke formation.

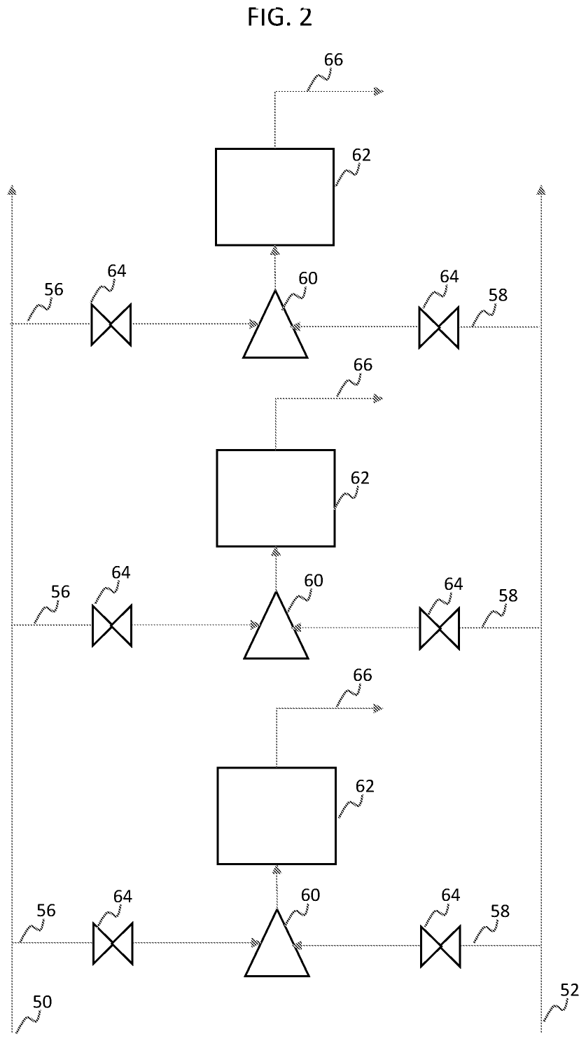

As illustrated in FIG. 1 a single stream is used in the example. However, embodiments herein are not limited to single stream reaction systems (one hydrocarbon feed, one reaction steam feed, one mixer, one adiabatic reactor, etc.). Referring now to FIG. 2, FIG. 2 shows a multiple streams/reactor concept, and may utilize as many mixing/reaction units as one wants. As illustrated in FIG. 2, a preheated hydrocarbon feed or a preheated hydrocarbon plus a small amount of dilution steam feed stream may be provided to a hydrocarbon flow header 50. Reaction steam may be provided to a reaction steam header 52. The respective headers 50, 52 may then provide hydrocarbon and reaction steam to multiple mixing/reaction/quench systems. Each mixing/reaction/quench system may include an inlet tube 56 for providing hydrocarbon from header 50 and an inlet tube 58 for providing reaction steam from header 52 to mixers 60 and reaction coils 62, producing cracked effluents 66 that may then be quenched and fed to a heat recovery and separation zone as described above with respect to FIG. 1. Quench may be performed by collectively or individually quenching the reaction effluent streams 66; in some embodiments each of the two or more reaction coils 62 is fluidly connected to a respective quench system, and in other embodiments, each of the two or more reaction coils 62 is fluidly connected to a collective quench system. Flow distribution to the multiple reaction coils and/or multiple inlet tubes may be controlled by flow control devices 64, which may be valves, flow venturis, or equivalent orifice plates used to distribute the flows uniformly to each mixer/reactor/quench system. In this arrangement many small reaction coils can be used, if economically attractive or providing a desired operating flexibility.

In some embodiments, the reaction coils as illustrated in FIG. 2 may be collectively grouped in a reaction bank, fluidly connected to a common steam drum and other utilities. For example, a reactor system including 2 to 20 reaction coils may be provided, in a common housing, where each of the reaction coils is fluidly connected to a hydrocarbon header and a steam header. This may be considered as a single reactor system having multiple reaction coils. In other embodiments, such as in FIG. 1, an adiabatic reactor may include only one large tube that is used as a reactor.

In other embodiments, a housing may contain multiple mixing/reaction systems, but may be provided hydrocarbons from multiple sources, such as a portion of the reaction coils being fluidly connected to a gas oil supply, and other reaction coils being fluidly connected to a naphtha supply. In this manner, a common steam source may be used to crack multiple feedstocks. As with other embodiments, such a system may include individual or collective quench systems.

As illustrated in FIG. 1, heating of the hydrocarbon or hydrocarbon plus dilution steam, as well as heating of the reaction steam is illustrated across a single exchanger or heater. Preheating of the hydrocarbon feed or dilution steam super heating can also be accomplished in multi-pass coil arrangements according to embodiments herein. The adiabatic reactor can also be a multi-pass coil (tubular) reactor instead of a large vessel. When tubular reactors are used, if additional heating is required, they can be supplemented with electrical heating when susceptor type of induction heating is used. Dilution steam superheating can also be an exchanger type if an electrical heater is not used. Similarly, exchanger type heating can also apply to hydrocarbon feed preheating.

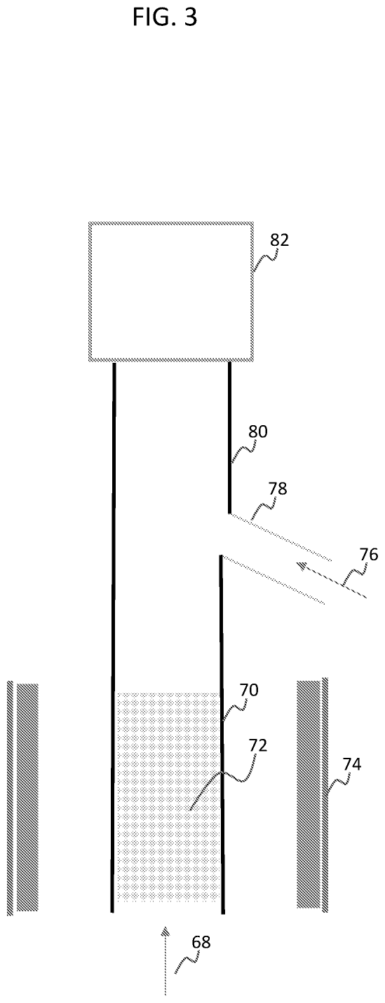

Referring now to FIG. 3, FIG. 3 shows a simplified flow diagram of a process according to embodiments herein using induction heating with susceptors (material packed in the tube) to provide the reaction steam. While not illustrated, induction heating with susceptors can be applied to heating fluid (hydrocarbon, hydrocarbon plus dilution steam, dilution steam, and/or reaction mixture). In this embodiment, the reaction steam 68 is provided to a feed tube 70 filled with susceptors 72. The susceptors are materials that are inductive particles. The susceptors are involved in inductive current circulation and cause heating, where the current is provided across electric coils 74. As a result, the susceptors can be heated to very high temperatures without heating the surrounding tube. The tube can also be an inductive material. Then both the susceptor and the tube are in the inductive loop and increase the temperature considerably. Under those conditions, the tube has to be capable of withstanding the high temperature. The superheated reaction steam is then mixed with a preheated hydrocarbon stream 76, provided via feed tube 78 forming a Y-type mixing device with an upper portion of feed tube 70. The resulting reaction mixture then proceeds through adiabatic reaction zone 80 and thence to quench zone 82.

With this approach the steam and the reaction mixture can be heated to very high temperatures (>1000° C.). Note that in the adiabatic section induction heating with and without susceptors can also be used. In place of susceptors, simple inert or catalyst packing can also be employed. With inert packing it promotes heat transfer only. Heating can be done with induction heating to the tubes or by radiative or direct heating by electricity. Since the adiabatic section performance is based on volume basis it can be a tubular reactor or a vessel.

There are advantages of using steam as the heating medium according to embodiments herein. Steam is an inert material and hence without fear of coking it can be heated to very high temperatures. Unlike air, it has high specific heat and good thermal properties. It is easily available in pure form and can be recirculated after condensing. It suppresses the coke formation in thermal cracking. With more dilution steam added, the partial pressure (and also the residence time) is reduced, improving the olefin selectivity.

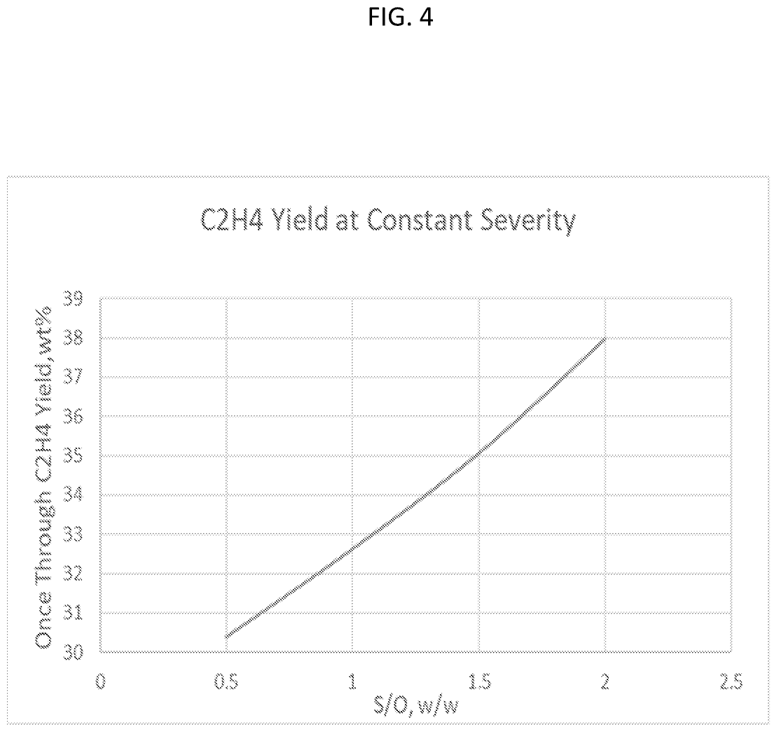

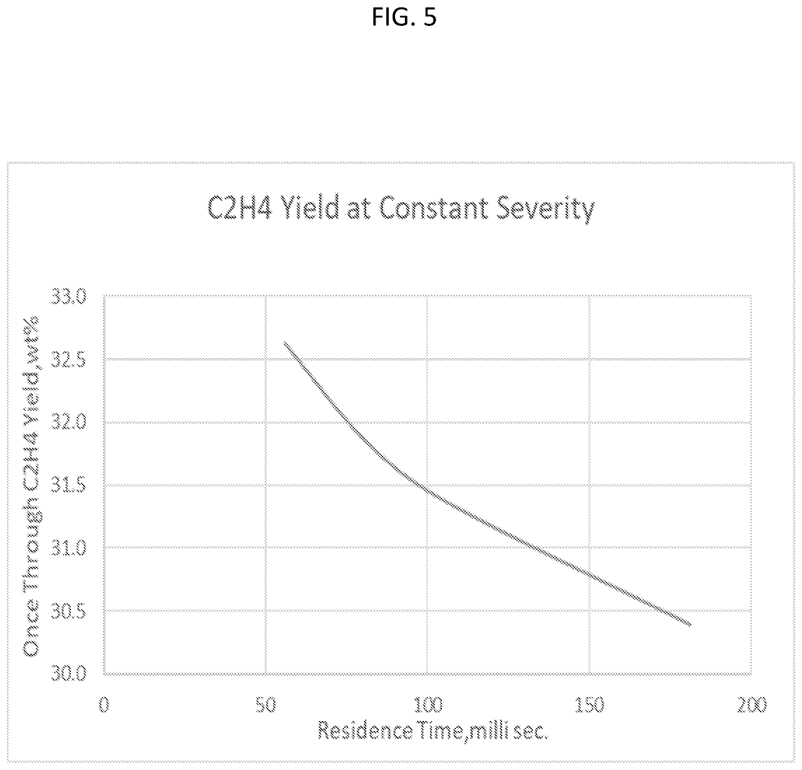

The increase in steam to oil (hydrocarbon) ratio to ethylene yield at constant severity for a naphtha feed is shown in FIG. 4. With increased steam to oil ratios, the maximum steam temperature required to achieve a desired conversion can be reduced. Also, it produces less fuel components like methane or fuel oil. At constant steam to oil ratio, increasing the steam temperature increases the volumetric flowrate of reaction mixture. For the fixed adiabatic volume, it reduces the residence time. By reducing the residence time to achieve the same severity also increases the ethylene yield. This is shown in FIG. 5.

As described above for embodiments herein, electrical heating can be used to thermally crack hydrocarbon feeds to produce olefins. By heating the steam and mixing the superheated reaction steam with preheated hydrocarbon (or hydrocarbon and dilution steam mixture), the resulting thermal cracking produces a significant amount of olefins. Coke deposition is minimized, and long run length can be achieved. Reducing the residence time with higher steam temperatures also increases the ethylene yield. In all cases when ethylene yield is increased at constant severity, valuable byproducts like propylene and butadiene are also increased. There is also a corresponding reduction of aromatics and fuel gas and fuel oil yields at higher steam temperatures. By controlling the flow rate and temperatures, severity can also be changed. As such, embodiments herein are good for all types of hydrocarbons to produce olefin and for all cases long run length can be obtained. The reactor can be easily on-line cleaned with steam/air mixture.

Unless defined otherwise, all technical and scientific terms used have the same meaning as commonly understood by one of ordinary skill in the art to which these systems, apparatuses, methods, processes and compositions belong.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

When the word “approximately” or “about” are used, this term may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed as new and desired to be protected by Letters Patent is:

1. A process of cracking hydrocarbons to produce olefins, the process comprising:
heating a hydrocarbon feedstock or a mixture comprising steam and hydrocarbons to a first temperature to form a preheated feed;
electrically heating steam to a second, higher, temperature to form a superheated reaction steam;
mixing the preheated feed with the superheated reaction steam to form a reaction mixture at a cracking temperature, and cracking the hydrocarbons to form olefins, producing a reaction effluent;
quenching the reaction effluent; and
separating the reaction effluent to recover the olefins.

2. The process of claim 1, wherein heating the mixture comprises heating the mixture of steam and hydrocarbons via one or more of:
inductively heating the mixture;
electrically radiatively heating the mixture;
heating the mixture using direct resistance type electrical heating elements;
heating the mixture via indirect heat exchange with an electrically heated heat exchange medium or the reaction effluent; or
combinations of two or more of these heating methods.

3. The process of claim 1, wherein the first temperature is a temperature in a range from 150° C. to 750° C.

4. The process of claim 1, wherein the electrically heating steam comprises one or more of:
inductively heating the steam;
electrically radiatively heating the steam;
heating the steam using direct resistance type electrical heating elements; or
combinations of two or more of these electrical heating methods.

5. The process of claim 1, wherein the second temperature is a temperature in a range from 950° C. to 1400° C.

6. The process of claim 1, wherein the cracking temperature is a temperature in a range from 900° C. to 1300° C.

7. The process of claim 1, wherein a residence time of the cracking is in a range from 10 to 500 milliseconds.

8. The process of claim 1, wherein the cracking is adiabatic.

9. The process of claim 1, wherein the cracking is non-isothermal and nonadiabatic.

10. The process of claim 1, wherein the mixture comprises steam and hydrocarbons at a steam to hydrocarbon ratio in a range from 0.05 to 0.6 (w/w).

11. The process of claim 1, wherein the reaction mixture comprises steam and hydrocarbons at a steam to hydrocarbon ratio in a range from 0.05 to 5 (w/w).

12. The process of claim 1, further comprising preheating a hydrocarbon stream and mixing the hydrocarbon stream with steam to form the mixture.

13. A system for cracking hydrocarbons to produce olefins, comprising:
a heating system configured for heating a mixture comprising steam and hydrocarbons to a first temperature to form a preheated mixture;
an electrical heating system configured for electrically heating steam to a second, higher, temperature to form a superheated reaction steam;
a mixing system configured for mixing the preheated mixture with the superheated reaction steam to form a reaction mixture at a cracking temperature;
an adiabatic reaction zone for adiabatically cracking the hydrocarbons to form olefins, producing a reaction effluent having a fourth temperature;
a quench system for quenching the reaction effluent; and
a separation system for separating the reaction effluent to recover the olefins.

14. The system of claim 13, wherein the electrical heating system comprises an inductive heating system with susceptors.

15. The system of claim 13, wherein the mixing system comprises a Y-type mixing device.

16. The system of claim 13, wherein the mixing system comprises a static mixer.

17. The system of claim 13, wherein the mixing system comprises a venturi mixer.

18. The system of claim 13, wherein the mixing system comprises two or more mixers, and wherein the adiabatic reaction zone comprises two or more adiabatic reactors, the system further comprising a hydrocarbon feed header for supplying the preheated mixture to each of the two or more mixers, a reaction steam header for supplying the superheated reaction steam to the two or more mixers, and wherein each of the two or more mixers is fluidly connected to or integral with a respective adiabatic reactor.

19. The system of claim 18, wherein a reaction effluent from each of the two or more adiabatic reactors is fluidly connected to a respective quench system.

20. The system of claim 18, wherein a reaction effluent from each of the two or more adiabatic reactors is fluidly connected to a collective quench system.
